(19) United States
(12) Patent Application Publication
(10) Pub. No.: US 2025/0256779 A1
(43) Pub. Date: Aug. 14, 2025

(54) SIDE SILL

(71) Applicant: SUBARU CORPORATION, Tokyo (JP)

(72) Inventors: Masaharu NOGUCHI, Tokyo (JP); Yuya MUKAINAKANO, Tokyo (JP); Hiroyasu ITO, Tokyo (JP); Shohei KANEMITSU, Tokyo (JP)

(21) Appl. No.: 19/169,850

(22) Filed: Apr. 3, 2025

Related U.S. Application Data
(63) Continuation of application No. PCT/JP2023/032864, filed on Sep. 8, 2023.

(51) Int. Cl. B62D 25/02; B62D 29/00

(52) U.S. Cl. CPC B62D 25/025; B62D 29/001

(57) ABSTRACT

A side sill includes a double structure that is made of a fiber-reinforced resin and that includes an outer peripheral tubular member and an inner peripheral tubular member extending in a front-back direction of a vehicle body of a vehicle. The outer peripheral tubular member and the inner peripheral tubular member extend in a front-back direction of a vehicle body. The inner peripheral tubular member includes ridge portions and coupling surface portions. The ridge portions each extend in the front-back direction of the vehicle body. The coupling surface portions are each formed between corresponding two of the ridge portions adjacent to each other around an axis. The inner peripheral tubular member is provided over at least a region to which the lower portion of the center pillar is coupled.

### CROSS REFERENCE TO RELATED APPLICATIONS

This application is continuation of International Application No. PCT/JP2023/032864, filed on Sep. 8, 2023, the entire contents of which are hereby incorporated by reference.

### BACKGROUND

The technology of the disclosure relates to a side sill.

In recent years, for the purpose of reducing the weight of a vehicle body of an automobile such as a passenger vehicle, it has been studied to produce a structural material of the vehicle body using a fiber-reinforced resin represented by carbon-fiber-reinforced plastic (hereinafter referred to as CFRP). The structural material made of the fiber-reinforced resin has high rigidity and exhibits high strength particularly against compressive stress or tensile stress acting in the orientation direction of fibers. For example, Japanese Unexamined Patent Application Publication No. 2020-062916 discloses a hollow frame made of a fiber-reinforced composite material, the frame being applicable to a center pillar and a side sill of a vehicle body structure.

### SUMMARY

An aspect of the disclosure provides a side sill. The side sill is configured to be coupled to a lower portion of a center pillar of a vehicle. The side sill includes a double structure made of a fiber-reinforced resin and comprising an outer peripheral tubular member and an inner peripheral tubular member that extend in a front-back direction of a vehicle body of the vehicle. The inner peripheral tubular member comprises ridge portions and coupling surface portions. The ridge portions each extending in the front-back direction of the vehicle body. Each of the coupling surface portions is provided between corresponding two of the ridge portions adjacent to each other around an axis. The inner peripheral tubular member is provided over at least a region to which the lower portion of the center pillar is coupled. Each of the coupling surface portions includes a recessed portion. The recessed portion is provided at an outer peripheral surface of the inner peripheral tubular member and extending in the front-back direction of the vehicle body. A vehicle body inner surface of the side sill has greater rigidity than a vehicle body upper surface, a vehicle body lower surface, and a vehicle body outer surface of the side sill, the vehicle body inner surface being disposed on a vehicle body inner side in a vehicle width direction and extending in a vertical direction of the vehicle body.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic view illustrating a vehicle body side structure including a side sill according to the present embodiment.

FIG. 2 is an explanatory view illustrating a state in which a coupling portion between a center pillar and the side sill is broken by a collision load.

FIG. 3 is a cross-sectional view illustrating an example of a configuration of the side sill according to the present embodiment.

FIG. 4 is an explanatory view schematically illustrating a shape change of the side sill according to the present embodiment.

FIG. 5 is an explanatory view illustrating a modification of the side sill according to the present embodiment.

FIG. 6 is an explanatory view illustrating another modification of the side sill according to the present embodiment.

### DETAILED DESCRIPTION

When a side sill made of a fiber-reinforced resin is employed, the fiber-reinforced resin has lower ductility than steel. Thus, when a collision load is applied to a center pillar and the side sill at the time of a side collision, stress may be concentrated on a coupling portion between the center pillar and the side sill, and the coupling portion may be broken.

It is desirable to provide a side sill capable of reducing a possibility that a coupling portion between a center pillar and the side sill may be broken due to a collision load at the time of a side collision when the side sill, to which a lower portion of the center pillar is coupled, is made of a fiber-reinforced resin.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

First, an outline of a vehicle body side structure including a side sill according to the present embodiment will be described.

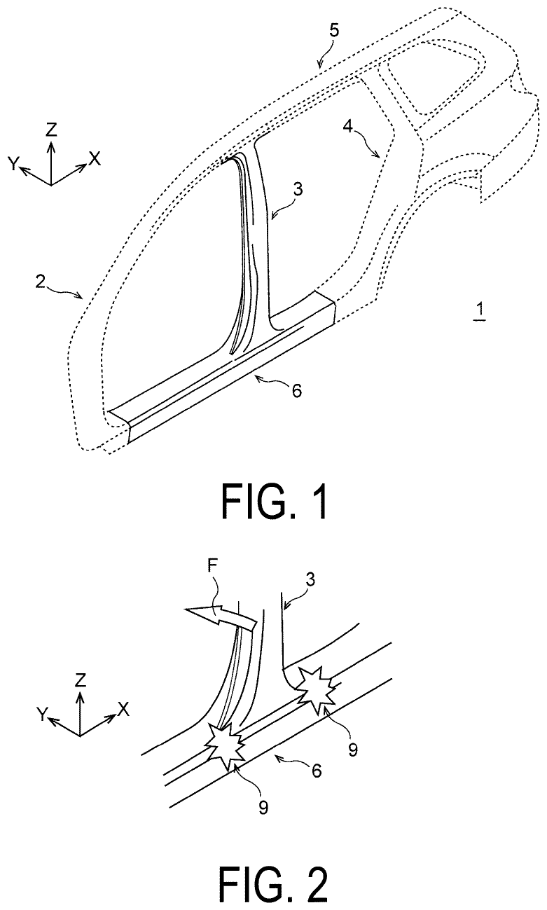

FIG. 1 is a schematic view illustrating an external appearance of a vehicle body side structure 1. As to the vehicle body side structure 1 illustrated in FIG. 1, a part of a structure of a left portion of the vehicle is schematically illustrated. Note that, as illustrated in FIG. 1, in the present specification, a front-back direction of the vehicle body may be referred to as an X direction, a vehicle width direction may be referred to as a Y direction, and a height direction of the vehicle body may be referred to as a Z direction.

The vehicle body side structure 1 includes a front pillar 2, a center pillar 3, a rear pillar 4, a roof pillar 5, a side sill 6, and the like. The roof pillar 5 extends along the front-back direction of the vehicle body at an upper portion of a vehicle cabin space of the vehicle, and forms a side portion of a roof of the vehicle. The side sill 6 extends along the front-back direction of the vehicle body at a lower portion of a side portion of the vehicle.

The front pillar 2 includes a lower end coupled to a front end of the side sill 6, and an upper end coupled to a front end of the roof pillar 5. The front pillar 2 forms a front portion constituting the vehicle cabin space of the vehicle, and is disposed to support a side of a windshield. The rear pillar 4 includes a lower end coupled to a rear end of the side sill 6, and an upper end coupled to a rear end of the roof pillar 5. The center pillar 3 includes a lower end coupled to a central portion of the side sill 6 in the front-back direction of the vehicle body, and an upper end coupled to a central portion of the roof pillar 5 in the front-back direction of the vehicle body.

An opening for a front door is formed between the side sill 6, the roof pillar 5, the front pillar 2, and the center pillar 3. An opening for a rear door is formed between the side sill 6, the roof pillar 5, the rear pillar 4, and the center pillar 3. Each of the structural components constituting the vehicle body side structure 1 may be constituted by combining members.

When at least the side sill 6 is made of CFRP and a collision load F applied at the time of a side collision is imposed on the center pillar 3 and the side sill 6 as illustrated in FIG. 2, the center pillar 3 may fall toward the inside of the vehicle body and a coupling portion 9 between the center pillar 3 and the side sill 6 may be broken. This is because the ductility of CFRP is lower than that of steel and is close to zero, so that stress is concentrated on the coupling portion 9. The side sill 6 according to the present embodiment is configured to be able to suppress such breakage of the coupling portion 9 between the center pillar 3 and the side sill 6.

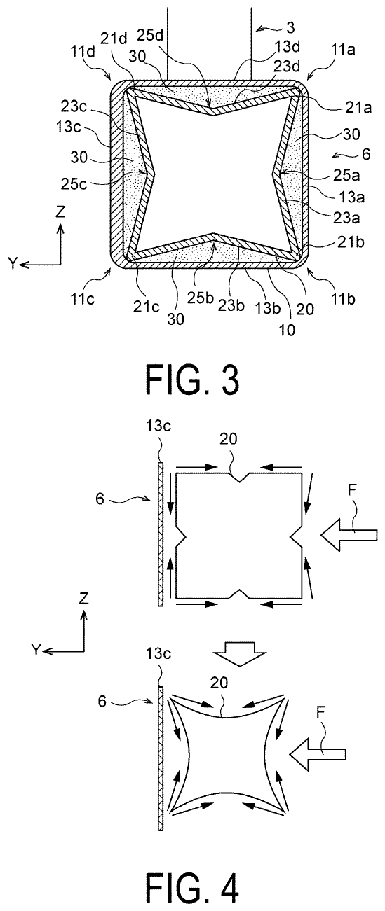

FIG. 3 is an explanatory view illustrating an example of a configuration of the side sill 6 according to the present embodiment. FIG. 3 is a cross-sectional view of the side sill 6 in the vicinity of a region to which the center pillar 3 is coupled in a cross section orthogonal to the front-back direction of the vehicle body.

The side sill 6 includes an outer peripheral tubular member 10, an inner peripheral tubular member 20, and an intermediate layer 30. Among these components, each of the outer peripheral tubular member 10 and the inner peripheral tubular member 20 is made of CFRP and formed into a hollow tubular shape extending along the front-back direction of the vehicle body. The illustrated side sill 6 has a double structure constituted of the outer peripheral tubular member 10 and the inner peripheral tubular member 20, and has a rectangular cross section orthogonal to the front-back direction of the vehicle body.

Each of the outer peripheral tubular member 10 and the inner peripheral tubular member 20 is formed of a fiber-reinforced resin obtained by impregnating carbon fibers with a thermoplastic resin or a thermosetting resin as a matrix resin.

Examples of the thermoplastic resin include a polyethylene resin, a polypropylene resin, a polyvinyl chloride resin, an acrylonitrile-butadiene-styrene copolymer synthetic resin (ABS resin), a polystyrene resin, an acrylonitrile-styrene copolymer synthetic resin (AS resin), a polyamide resin, a polyacetal resin, a polycarbonate resin, a polyester resin, a polyphenylene sulfide (PPS) resin, a fluororesin, a polyetherimide resin, a polyetherketone resin, a polyimide resin, and the like.

The thermoplastic resin may be one of the above resins or a mixture of two or more of the above resins. Alternatively, the thermoplastic resin may be a copolymer of the above resins. When the thermoplastic resin is a mixture, a compatibilizing agent may be further used together. Furthermore, a bromine-based flame retardant, a silicon-based flame retardant, red phosphorus, or the like may be added to the thermoplastic resin as a flame retardant.

Examples of the thermosetting resin include an epoxy resin, an unsaturated polyester resin, a vinyl ester resin, a phenol resin, a polyurethane resin, and a silicone resin. The thermosetting resin may be one of the above resins or a mixture of two or more of the above resins. An appropriate curing agent or reaction accelerator may be added to the thermosetting resin.

The carbon fibers contain, at an appropriate ratio, continuous fibers oriented in the front-back direction of the vehicle body and continuous fibers oriented in a direction intersecting the front-back direction of the vehicle body. Tensile stress generated when a load is applied due to a side collision can be adjusted by the amount of the continuous fibers oriented in the front-back direction of the vehicle body. By the amount of the continuous fibers oriented in the direction intersecting the front-back direction of the vehicle body, the rigidity against a load applied at the time of a side collision can be adjusted, and the amount of energy absorption can be adjusted. Further, the carbon fibers may contain short fibers in addition to the continuous fibers, and fibers other than the carbon fibers may be contained as reinforced fibers.

Each of the outer peripheral tubular member 10 and the inner peripheral tubular member 20 is a molded body having a tubular closed cross-sectional shape. Thus, the continuity of the fibers can be maintained not only in the axial direction (the front-back direction of the vehicle body) but also in the circumferential direction around the axis, and the rigidity against a load applied at the time of a side collision can be enhanced.

The outer peripheral tubular member 10 include four ridge portions 11a to 11d extending in the front-back direction of the vehicle body and four coupling surface portions 13a to 13d. Each of the four coupling surface portions 13a to 13d is formed between corresponding two of the ridge portions 11a to 11d adjacent to each other around the axis. The inner peripheral tubular member 20 include four ridge portions 21a to 21d extending in the front-back direction of the vehicle body and four coupling surface portions 23a to 23d. Each of the four coupling surface portions 23a to 23d is formed between corresponding two of the ridge portions 21a to 21d adjacent to each other around the axis.

Each of the four coupling surface portions 13a to 13d of the outer peripheral tubular member 10 has a flat surface shape. Among these coupling surface portions, the coupling surface portion 13c on the vehicle body inner side in the vehicle width direction is thicker than the coupling surface portion 13d on the vehicle body upper side, the coupling surface portion 13b on the vehicle body lower side, and the coupling surface portion 13a on the vehicle body outer side. Accordingly, the coupling surface portion 13c on the vehicle body inner side in the vehicle width direction has greater rigidity than the coupling surface portion 13d on the vehicle body upper side, the coupling surface portion 13b on the vehicle body lower side, and the coupling surface portion 13a on the vehicle body outer side. Note that, considering the side sill 6 as a whole, the vehicle body inner portion in the vehicle width direction has greater rigidity than the vehicle body upper portion, the vehicle body lower portion, and the vehicle body outer portion in the vehicle width direction.

Each of the four coupling surface portions 23a to 23d of the inner peripheral tubular member 20 has a cross-sectional shape recessed relative to the outer peripheral side of the inner peripheral tubular member 20. Accordingly, the four coupling surface portions 23a to 23d of the inner peripheral tubular member 20 include recessed portions 25a to 25d, respectively. The recessed portions 25a to 25d are provided at the outer peripheral surfaces of the inner peripheral tubular member 20 and extend in the front-back direction of the vehicle body.

The four ridge portions 11a to 11d of the outer peripheral tubular member 10 and the four ridge portions 21a to 21d of the inner peripheral tubular member 20 are in contact with each other. Thus, the inner peripheral tubular member 20 is fixed in a space on the inner peripheral side of the outer peripheral tubular member 10. On the other hand, since the four coupling surface portions 23a to 23d of the inner peripheral tubular member 20 have a recessed cross-sectional shape, the four coupling surface portions 13a to 13d of the outer peripheral tubular member 10 and the four coupling surface portions 23a to 23d of the inner peripheral tubular member 20 are separated from each other.

The intermediate layers 30 are disposed in regions between the coupling surface portions 13a to 13d of the outer peripheral tubular member 10 and the coupling surface portions 23a to 23d of the inner peripheral tubular member 20. The intermediate layers 30 are formed of a member having lower rigidity than the outer peripheral tubular member 10 and the inner peripheral tubular member 20. Each intermediate layer 30 may be, for example, a layer filled with a foam material made of polyethylene, polystyrene, polypropylene, polyurethane, or the like, but the material constituting the intermediate layer 30 is not limited to the above-described examples.

In the side sill 6, the outer peripheral tubular member 10 defines the outer shape of the side sill 6, and the coupling surface portion 13c of the outer peripheral tubular member 10 on the vehicle body inner side has a function of receiving a collision load at the time of a side collision. Further, the inner peripheral tubular member 20 has a function of receiving the collision load at the time of the side collision so as to easily crush the cross section of the side sill 6 uniformly, thereby dispersing stress in a wide range of the side sill 6 and exhibiting the energy absorption of the collision load. The intermediate layers 30 have a function of transmitting the load received by the outer peripheral tubular member 10 to the inner peripheral tubular member 20 and increasing the energy absorption amount of the collision load by being compressed by the load.

FIG. 4 is an explanatory view schematically illustrating a shape change of the side sill 6 according to the present embodiment when a collision load F is applied to the side sill 6 at the time of a side collision.

When the collision load F is applied to the side sill 6, the inner peripheral tubular member 20 starts to be deformed by the collision load F. The coupling surface portion 13c of the outer peripheral tubular member 10 on the vehicle body inner side has higher rigidity than the other portions and is less likely to be deformed when receiving the collision load F transmitted via the inner peripheral tubular member 20. Thus, the inner peripheral tubular member 20 is likely to be crushed by the collision load F. At this time, since the recessed portions are provided at the outer peripheral surfaces of the respective coupling surface portions of the inner peripheral tubular member 20, the coupling surface portions of the inner peripheral tubular member 20 are deformed toward the axial center.

As a result, the cross section of the inner peripheral tubular member 20 is uniformly crushed, and stress can be dispersed over a wide range of the side sill 6. Further, since the cross section of the inner peripheral tubular member 20 is uniformly crushed, the energy absorption of the collision load is exhibited. Thus, it is possible to suppress breakage of the coupling portion between the center pillar 3 and the side sill 6 due to concentration of stress on the coupling portion.

The configuration of the side sill 6 according to the present embodiment can be modified in various ways. Some modifications will be described below.

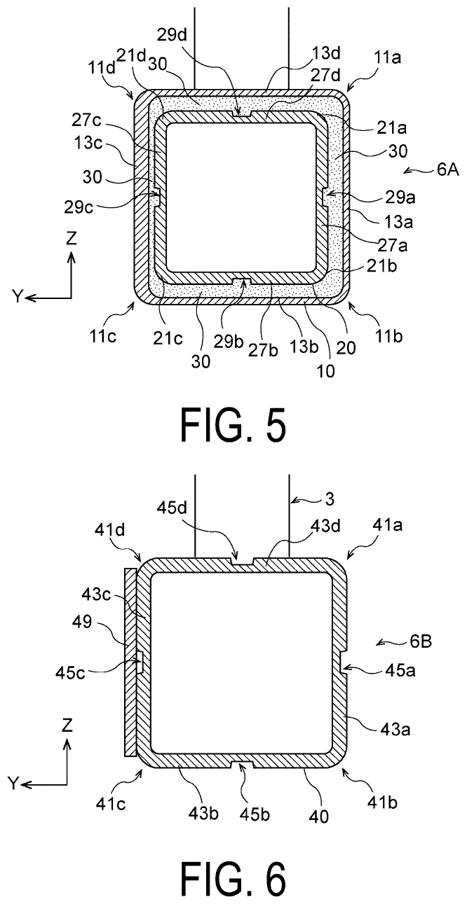

FIG. 5 illustrates a side sill 6A according to a modification in which the shape of the inner peripheral tubular member 20 is changed.

Coupling surface portions 27a to 27d of the inner peripheral tubular member 20 of the side sill 6A have a substantially flat surface shape. The coupling surface portions 27a to 27d include recessed portions 29a to 29d, respectively. The recessed portions 29a to 29d are provided at the outer peripheral surfaces of the inner peripheral tubular member 20 and extend in the front-back direction of the vehicle body. The recessed portion 29a is formed as a portion having a relatively small layer thickness. That is, each of the coupling surface portions 27a to 27d has the recessed portion 29a to 29d and a non-recessed portion adjacent to the recessed portion, and a thickness of the recessed portion 29a to 29d is smaller than a thickness of the non-recessed portion. An outer peripheral tubular member 10 has the same configuration as the outer peripheral tubular member 10 of the side sill 6 according to the above-described embodiment. In addition, an intermediate layer 30 is provided in a region between the outer peripheral tubular member 10 and the inner peripheral tubular member 20.

Even in the side sill 6A illustrated in FIG. 5, when a collision load is applied at the time of a side collision, the coupling surface portions 27a to 27d of the inner peripheral tubular member 20 are deformed toward the axial center with the recessed portions 29a to 29d of the inner peripheral tubular member 20 as a start. As a result, the cross section of the inner peripheral tubular member 20 is uniformly crushed, and stress can be dispersed over a wide range of the side sill 6A. Further, since the cross section of the inner peripheral tubular member 20 is uniformly crushed, the energy absorption of the collision load is exhibited. Thus, it is possible to suppress breakage of the coupling portion between the center pillar 3 and the side sill 6A due to concentration of stress on the coupling portion.

FIG. 6 illustrates a side sill 6B according to a modification in which a single tubular member 40 is used instead of a double structure.

The tubular member 40 of the side sill 6B is configured in the same manner as the inner peripheral tubular member 20 of the side sill 6A of the modification illustrated in FIG. 5. A reinforcing plate 49 is joined to a surface of a coupling surface portion 43c on the vehicle body inner side of the tubular member 40 in the vehicle width direction. The surface to which the reinforcing plate 49 is joined is on a further inner side of the vehicle body than the coupling surface portion 43c. The reinforcing plate 49 is provided in order that a vehicle body inner portion of the side sill 6B, which is disposed on the vehicle body inner side in the vehicle width direction and which extends in the vertical direction of the vehicle body, has higher rigidity than a vehicle body upper portion, a vehicle body lower portion, and a vehicle body outer portion of the side sill 6B. The reinforcing plate 49 is a plate made of CFRP from the viewpoint of weight reduction, but may be a plate made of metal.

Even in the side sill 6B illustrated in FIG. 6, when a collision load is applied at the time of a side collision, coupling surface portions 43a to 43d of the tubular member 40 are deformed toward the axial center with recessed portions 45a to 45d of the tubular member 40 as a start. Thus, the cross section of the tubular member 40 is uniformly crushed, and stress can be dispersed over a wide range of the side sill 6B. In addition, since the cross section of the tubular member 40 is uniformly crushed, the energy absorption of the collision load is exhibited. Thus, it is possible to suppress breakage of the coupling portion between the center pillar 3 and the side sill 6B due to concentration of stress on the coupling portion.

A preferred embodiment of the technology of the disclosure has been described above in detail with reference to the accompanying drawings, but the technology of the disclosure is not limited to the example. It is apparent to those skilled in the art with common knowledge in the technical field of the disclosure that various variations and modifications may be conceived within the scope of the technical ideas described in the claims. Thus, it is acknowledged that those variations and modifications are also naturally included in the technical scope of the disclosure.

For example, in the above-described embodiment, the layer thickness is increased or the reinforcing plate 49 is provided in order to increase the rigidity of the vehicle body inner surface (13c, 49) that is disposed on the vehicle body inner side of the side sill in the vehicle width direction and that extends in the vertical direction of the vehicle body, but the technology of the disclosure is not limited to such an example. For example, the rigidity may be increased by providing a three-dimensional uneven shape at the coupling surface portion 13c or the reinforcing plate 49 on the vehicle body inner side. Further, the rigidity may be increased by increasing the proportion of continuous fibers oriented in a direction of 0° or 90° with respect to the front-back direction of the vehicle body as the continuous fibers constituting the coupling surface portion 13c or the reinforcing plate 49 on the vehicle body inner side.

Further, in the above-described embodiment, the space on the inner peripheral side of the inner peripheral tubular member 20 or the tubular member 40 is hollow, but the technology of the disclosure is not limited to such an example. For example, by disposing the same member as the intermediate layer 30 in the space on the inner peripheral side of the inner peripheral tubular member 20 or the tubular member 40, it is possible to increase the energy absorption amount without preventing the inner peripheral tubular member 20 or the tubular member 40 from being crushed toward the axial center.

In the above-described embodiment, an example in which the side sill has a rectangular cross-sectional shape has been described. However, the cross-sectional shape of the side sill is not limited to a rectangular shape. For example, the cross-sectional shape may be a polygonal shape such as a hexagon or octagon.

As described above, according to the technology of the disclosure, it is possible to reduce a possibility that a coupling portion between a center pillar and a side sill may be broken due to a collision load at the time of a side collision when the side sill, to which a lower portion of the center pillar is coupled, is made of a fiber-reinforced resin.

1. A side sill configured to be coupled to a lower portion of a center pillar of a vehicle, the side sill comprising
a double structure made of a fiber-reinforced resin and comprising an outer peripheral tubular member and an inner peripheral tubular member that extend in a front-back direction of a vehicle body of the vehicle, wherein
the inner peripheral tubular member comprises ridge portions and coupling surface portions, the ridge portions each extending in the front-back direction of the vehicle body, the coupling surface portions each being provided between corresponding two of the ridge portions adjacent to each other around an axis, the inner peripheral tubular member being provided over at least a region to which the lower portion of the center pillar is coupled,
each of the coupling surface portions comprises a recessed portion, the recessed portion being provided at an outer peripheral surface of the inner peripheral tubular member and extending in the front-back direction of the vehicle body, and
a vehicle body inner surface of the side sill has greater rigidity than a vehicle body upper surface, a vehicle body lower surface, and a vehicle body outer surface of the side sill, the vehicle body inner surface being disposed on a vehicle body inner side in a vehicle width direction and extending in a vertical direction of the vehicle body.

2. The side sill according to claim 1, wherein
each of the coupling surface portions has a cross-sectional shape recessed relative to an outer peripheral side of the inner peripheral tubular member.

3. The side sill according to claim 1, wherein
a member having lower rigidity than each of the outer peripheral tubular member and the inner peripheral tubular member is disposed in a region between the outer peripheral tubular member and the inner peripheral tubular member.

4. The side sill according to claim 1, wherein
the vehicle body inner surface of the side sill having the double structure has greater rigidity than the vehicle body upper surface, the vehicle body lower surface, and the vehicle body outer surface of the side sill.

5. The side sill according to claim 1, wherein
the inner peripheral tubular portion has a rectangular cross-sectional shape comprising four of the ridge portions and four of the coupling surface portions, the four coupling surface portions each being formed between corresponding two of the four ridge portions adjacent to each other around the axis, and
each of the four coupling surface portions comprises the recessed portion at the outer peripheral surface of the inner peripheral tubular member.

6. The side sill according to claim 1, wherein the recessed portion has a relatively small layer thickness.
